(19) United States
(12) Patent Application Publication
(10) Pub. No.: US 2007/0212558 A1
(43) Pub. Date: Sep. 13, 2007

(54) SURFACE TREATMENT PROCESS FOR METAL ARTICLES

(75) Inventors: DE-FENG GAO, Shenzhen (CN); XIAO-PENG ZHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/616,827

(22) Filed: Dec. 27, 2006

(30) Foreign Application Priority Data
Mar. 10, 2006 (CN) 200610034364.7

(51) Int. Cl. B05D 3/00; B32B 15/04

(52) U.S. Cl. 428/469; 428/472; 427/271

(57) ABSTRACT

A surface treatment process for metal articles for a mobile device includes following steps. Firstly, a metal article made of aluminum, titanium, or alloys thereof, is provided. Secondly, a first releasable coating is formed on a first surface portion of the metal article. Thirdly, a metal coating is formed on a second surface portion of the metal article. Fourthly, the first releasable coating is removed from the first surface portion of the metal article. Fifthly, a second releasable coating is formed on the metal coating. Sixthly, the first surface portion of the metal article is anodized. Finally, the second releasable coating is removed from the second surface portion of the metal article.

### BACKGROUND OF THE INVENTION

1. Field of the Invention

The present invention relates generally to surface treatment processes for metal articles, and more particularly, to a surface treatment process for improving conductivity of anodized metal articles.

2. Discussion of the Related Art

Metal articles made of aluminum, titanium, or alloys thereof, with high quality in mechanical performance have tremendous applications in many industries. The articles usually need to be processed via surface treatment process for improving corrosion resistance or abrasion resistance.

Anodizing is a well-known surface treatment carried out on metal articles for the purpose of improving the decorative quality and/or surface durability of the metal articles. An anodized film is formed over the surface of the metal articles after anodizing of the metal articles. The anodized film is an insulative metal oxide coating. Sometimes, a portion of surface of an anodized metal article is etched to expose a metal body of the metal article, so as to electrically connect to other electronic articles. However, the anodized metal body exposed to environment is liable to be oxidized and etched, thus the conductivity of the anodized metal article may be reduced, which may cause failure in electrical connections.

Therefore, a surface treatment processes for metal articles is desired in order to overcome the above-described shortcomings

### SUMMARY

In one embodiment thereof, a surface treatment process for metal articles for a mobile device is provided. In a first step of the surface treatment process, a metal article is provided. The metal article has a surface consisting of a first portion and a second portion. In a second step of the surface treatment process, a first releasable coating is formed on the first surface portion of the metal article. In a third step of the surface treatment process, a metal coating is formed on the second surface portion of the metal article. In a fourth step of the surface treatment process, the first releasable coating is removed from the first surface portion of the metal article. In a fifth step of the surface treatment process, a second releasable coating is formed on the metal coating. In a sixth step of the surface treatment process, the first surface portion of the metal article is anodized. Finally, the second releasable coating is removed from the second surface portion of the metal article.

Other advantages and novel features will become more apparent from the following detailed description of preferred embodiments when taken in conjunction with the accompanying drawings.

### BRIEF DESCRIPTION OF THE DRAWINGS

Many aspects of the surface treatment process for metal articles can be better understood with reference to the following drawing. The components in the drawing are not necessarily drawn to scale, the emphasis instead being placed upon clearly illustrating the principles of the surface treatment process for metal articles. Moreover, in the drawing like reference numerals designate corresponding parts throughout the several views.

FIG. 1 is a flow chart of a surface treatment process for metal articles in accordance with a first embodiment of the present invention.

FIG. 2 is a flow chart of a surface treatment process for metal articles in accordance with a second embodiment of the present invention.

### DETAILED DESCRIPTION OF THE PREFERRED EMBODIMENTS

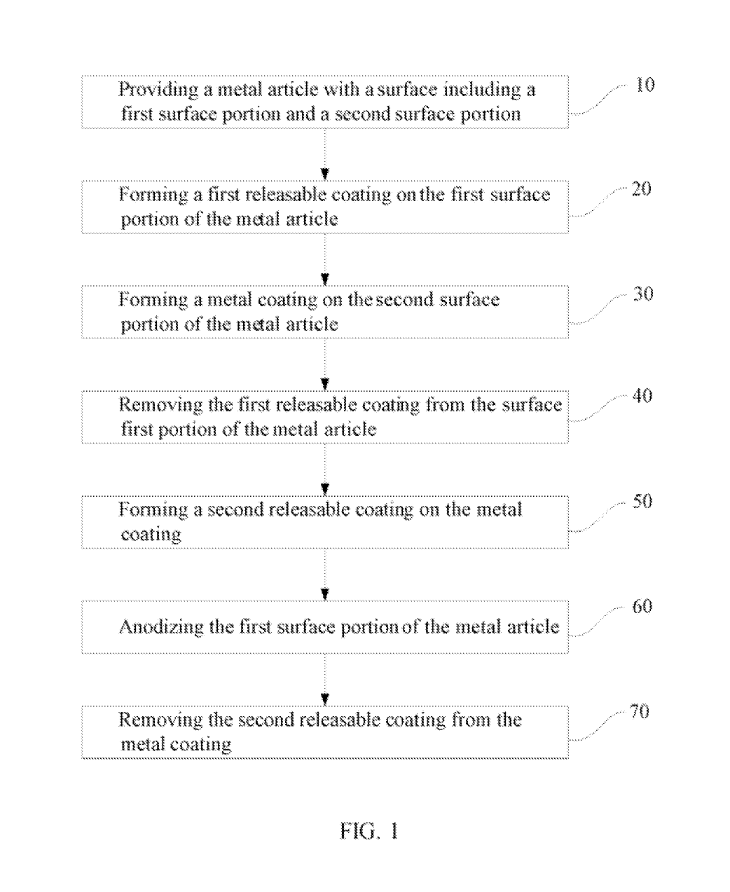

Referring to FIG. 1, in a first preferred embodiment, a surface treatment process for metal articles includes steps 10 to 50. In step 10, a metal article made of aluminum, titanium, or alloys thereof is provided, and the metal article has a surface including a first portion and a second portion. In step 20, a first releasable coating is formed on the first surface portion of the metal article. In step 30, a metal coating is formed on the second surface portion of the metal article. In step 40, the first releasable coating is removed from the first surface portion of the metal article. In step 50, a second releasable coating is formed on the metal coating. In step 60, the first surface portion of the metal article is anodized. In step 70, the second releasable coating is removed from the second surface portion of the metal article. Detailed description about the above steps is as following:

Firstly, a metal article made of aluminum, titanium, or alloys thereof is provided. The metal article has a surface including a first surface portion and a second surface portion. The second surface portion is used for electrically connecting to another article for discharging electricity.

Secondly, a first releasable coating is formed on the first surface portion of the metal article, so as to prevent the first surface portion of the metal article from being coated in a subsequent deposition process. The first releasable coating may be a resoluble resin system, such as resoluble ink and resoluble resin paint. A process for forming the first releasable coating on the first surface portion of the metal article may be brushing, spray painting, or screen printing.

Thirdly, a metal coating with high conductivity is deposited on the second surface portion of the metal part. The metal coating preferably should be copper or gold. The metal coating preferably should be electroplated onto the second surface portion of the metal article.

Fourthly, the first releasable coating is removed from the first surface portion of the metal article, so as to expose the first surface portion of the metal article. The first releasable coating may be removed using a solvent. An organic solvent is used to dissolve and remove the first releasable coating. The organic solvent may be chosen from the group consisting of methyl alcohol, ethanol, propylene glycol ether, benzene and phenol.

Fifthly, a second releasable coating is formed on the metal coating, so as to protect the metal coating from being anodized in a subsequent anodization process. The second releasable coating may be a resoluble resin system, such as resoluble ink and resoluble resin paint. The second releasable coating on the metal coating may be applied by brushing, spray painting, or screen printing.

An anodizing process is then applied to the surface of the metal article, thus an anodized coating is formed on the first portion of the metal article, and the metal coating formed on the second portion of the metal article could not be anodized because of the protection of the second releasable coating. The process for anodizing the metal articles involves a cleaning step and an electrolysis step. The cleaning step is carried out in an alkaline solution, such as sodium hydroxide or sodium carbonate. The electrolysis step should preferably be carried out in an electrolyte containing 0.2˜1.0 wt. % sulphuric acid, using the metal article as an anode. The metal article is anodized in the electrolyte using a current density of 10˜50 milliamperes per square centimeter, at a temperature in an approximate range from 20 minutes. As the electrolysis proceeds, an anodized film of metal oxide grows on the first portion of the surface of the metal surface, with the thickness of the film increasing as the electrolysis continues.

Finally, the second releasable coating is removed from the metal article, so as to expose the metal coating. The second releasable coating may be removed with a solvent. In the method of solvent cleaning, an organic solvent is used to dissolve and clean off the first releasable coating. The organic solvent may be chosen from the group consisting of methyl alcohol, ethanol, propylene glycol ether, benzene and phenol. Thus, a metal article with the first portion covered by the anodized film and the second portion covered by the metal coating is obtained.

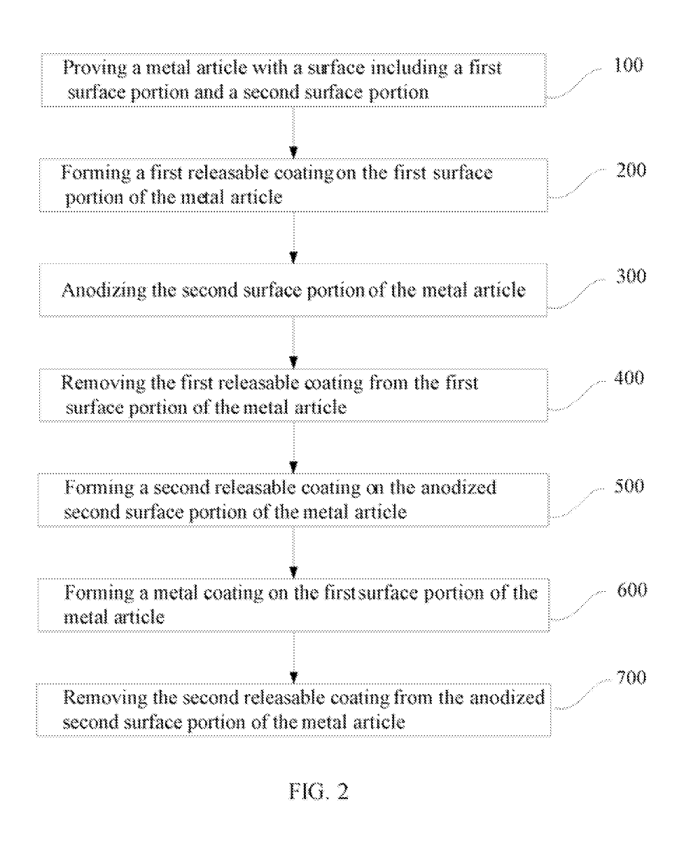

Referring to FIG. 2, in a second preferred embodiment, a surface treatment process for metal articles includes steps 100 to 700.

In step 100, a metal article made of aluminum, titanium, or alloys thereof, is provided with a surface consisting of a first portion and a second portion. The first portion is used for electrically connecting to other electronic articles.

In step 200, a first releasable coating is formed on the first portion. The process for forming the first releasable coating is the same as that described in the first preferred embodiment.

In step 300, the second portion is anodized. The process for anodizing the second portion is the same as that described in the first preferred embodiment.

In step 400, the first releasable coating is removed from the first portion. The process for removing the first releasable coating is the same as that described in the first preferred embodiment.

In step 500, a second releasable coating is formed on the anodized second portion. The process for forming the second releasable coating is the same as that described in the first preferred embodiment.

In step 600, a metal coating with high conductivity is formed on the first portion. The process for forming the metal coating is the same as that described in the first preferred embodiment.

In step 700, the second releasable coating is removed from the anodized second portion of the surface of the metal article, so as to obtain an anodized metal article with high conductivity. The process for removing the second releasable coating is the same as that described in the first preferred embodiment.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A surface treatment processes for metal articles, comprising steps of:
providing a metal article with a surface including a first surface portion and a second surface portion;
forming a first releasable coating on the first surface portion of the metal article;
forming a metal coating on the second surface portion of the metal article;
removing the first releasable coating from the first surface portion of the metal article;
forming a second releasable coating on the metal coating;
anodizing the first surface portion of the metal article; and
removing the second releasable coating from the metal coating.

2. The surface treatment processes for metal articles as claimed in claim 1, wherein the metal article is made of aluminum, titanium, or alloys.

3. The surface treatment processes for metal articles as claimed in claim 1, wherein the first releasable coating and the second releasable coating consist of resoluble ink.

4. The surface treatment processes for metal articles as claimed in claim 1, wherein the first releasable coating and the second releasable coating consist of resoluble resin paint.

5. The surface treatment processes for metal articles as claimed in claim 1, wherein the metal coating is made of a substance chosen from the group including copper and gold.

6. The surface treatment processes for metal articles as claimed in claim 1, wherein the metal coating is formed using an electroplating process.

7. The surface treatment processes for metal articles as claimed in claim 1, wherein the anodizing process for the metal articles involves a cleaning step and an electrolysis step, the cleaning step is carried out in an alkaline solution, the electrolysis step is carried out in an electrolyte containing 0.2˜1.0 wt. % sulphuric acid, using the metal article as an anode.

8. The surface treatment processes for metal articles as claimed in claim 7, wherein in the anodizing process for the metal article, the metal article is anodized in the electrolyte at a current density of 10˜50 milliamperes per square centimeter, at a temperature in a range from 20° C. to 26° C. for 20 minutes.

9. A surface treatment processes for metal articles, comprising steps of:
providing a metal article with a surface consisting of a first surface portion and a second surface portion;
forming a first releasable coating on the first surface portion of the metal article;
anodizing the second surface portion of the metal article;
removing the first releasable coating from the first surface portion of the metal article;
forming a second releasable coating on the anodized second portion of the surface of the metal article;
forming a metal coating on the first surface portion of the metal article; and
removing the second releasable coating from the anodized second portion of the surface of the metal article.

10. The surface treatment processes for metal articles as claimed in claim 9, wherein the metal article is made of aluminum, titanium, or alloys thereof.

11. The surface treatment processes for metal articles as claimed in claim 9, wherein the first releasable coating and the second releasable coating consist of a resoluble ink.

12. The surface treatment processes for metal articles as claimed in claim 9, wherein the first releasable coating and the second releasable coating consist of a resoluble resin paint.

13. The surface treatment processes for metal articles as claimed in claim 9, wherein the metal coating includes a substance chosen from the group consisting of copper and gold.

14. The surface treatment processes for metal articles as claimed in claim 9, wherein the metal coating is formed using an electroplating process.

15. The surface treatment processes for metal articles as claimed in claim 9, wherein the anodizing process for the metal articles involves a cleaning step and an electrolysis step, the cleaning step is carried out in an alkaline solution, the electrolysis step is carried out in an electrolyte containing 0.2˜1.0 wt. % sulphuric acid, using the metal article as an anode.

16. The surface treatment processes for metal articles as claimed in claim 15, wherein in the anodizing process for the metal article, the metal article is anodized in the electrolyte at a current density of 10˜50 milliamperes per square centimeter, at a temperature in a range from 20° C. to 26° C. for 20 minutes.

17. An anodized metal article, comprising:
a surface including a first portion and a second portion, wherein the first portion is anodized to form an anodized film, the second portion is covered by a metal coating and configured to electrically connect to other parts for discharging static electricity.

18. The anodized metal articles as claimed in claim 17, wherein the metal article is made of aluminum, titanium, or alloys thereof.

19. The anodized metal articles as claimed in claim 17, wherein the metal coating is made of copper or gold.

20. The anodized metal articles as claimed in claim 19, wherein the metal coating is formed using an electroplating process.
